(19) United States
(12) Patent Application Publication
(10) Pub. No.: US 2024/0174814 A1
(43) Pub. Date: May 30, 2024

(54) METHOD FOR PRODUCING ORGANOPOLYSILOXANES WITH UNSATURATED GROUPS

(71) Applicant: Wacker Chemie AG, Munich (DE)

(72) Inventors: Markus Merget, Mehring (DE); Johann Bindl, Burghausen (DE)

(73) Assignee: Wacker Chemie AG, Munich (DE)

(21) Appl. No.: 18/280,693

(22) PCT Filed: Mar. 24, 2021
(86) PCT No.: PCT/EP2021/057606

§ 371 Date: Sep. 7, 2023

(51) Int. Cl. C08G 77/20; C08G 77/10; C08G 83/00

(52) U.S. Cl. CPC C08G 77/20; C08G 77/10; C08G 83/003

(57) ABSTRACT

A method for producing organopolysiloxanes having unsaturated groups. Where the organopolysiloxanes produced include organopolysiloxanes (A), organopolysiloxanes (B), catalysts (D) and optionally organopolysiloxane compounds (C).

The invention relates to a method for producing organopolysiloxanes having unsaturated groups by base-catalyzed equilibration or condensation.

The preparation of functional organopolysiloxanes via alkali-catalyzed equilibration is described in many publications and in the prior art. For instance, catalysts such as alkali metal, ammonium and phosphonium hydroxides or sil(ox)anolates are known, for example from J. Polym. Sci., Part C No. 16, 669-677 (1967); Makromol. Chem., Macromol. Symp. 6, 67-80 (1986); and Polym. Prepr. 29 (1), 123-125 (1988).

EP 628589 B1 describes the use of strontium hydroxide or barium hydroxide together with sodium borates or sodium phosphates. However, in the methods described therein, metal hydroxides have the disadvantage that they have to be neutralized with acids for deactivation at the end of the reaction. This leads to undesired turbidity and precipitates in salt form.

EP-A 2055777 describes a multi-stage process for preparing organopolysiloxane comprising aminoalkyl groups. The basic catalyst here can be deactivated with long-chain carboxylic acids.

The object of the invention is to provide an advantageous method for producing unsaturated organopolysiloxanes. The object is achieved by the invention.

The invention relates to a method for producing organopolysiloxanes having unsaturated groups, wherein
in a first step
organopolysiloxanes (A) comprising units of the formula

RₐQ_{b}SiO_{(4-a-b)/2} (I),
where
R may be the same or different and is a monovalent, saturated hydrocarbon radical having 1 to 18 carbon atoms and optionally substituted by fluorine, chlorine or bromine atoms,
Q may be the same or different and is unsaturated hydrocarbon radicals which may comprise aromatic and/or aliphatic double bonds,
a is 0, 1, 2 or 3, preferably 1, 2 or 3, and
b is 0, 1, 2 or 3, preferably 0 or 1,
with the proviso that the sum of a+b is ≤3 and the siloxanes (A) have at least one radical Q,
organopolysiloxanes (B) comprising units of the formula

R²_{d}(OR¹)_{f}SiO_{(4-d-f)/2} (II),
where
R² may be the same or different and is a monovalent, saturated hydrocarbon radical having 1 to 18 carbon atoms and optionally substituted by fluorine, chlorine or bromine atoms,
R¹ may be the same or different and is a hydrogen atom or alkyl radicals having 1 to 4 carbon atoms which may be substituted by oxygen atoms,
d is 0, 1, 2 or 3, preferably 2, and
f is 0, 1, 2 or 3, preferably 0 or 1,
with the proviso that the sum of d+f is ≤3,
optionally organopolysiloxane compounds (C) comprising at least one structural unit per molecule of the general formula

O_{3-(e+g)/2}R³ₑQ¹_{g}Si—Y(SiR³ₑQ¹_{g}O_{3-(e+g)/2})_{c} (III)
where
R³ may be the same or different and is a monovalent, saturated hydrocarbon radical having 1 to 18 carbon atoms and optionally substituted by fluorine, chlorine or bromine atoms,
Q¹ may be the same or different and is unsaturated hydrocarbon radicals which may comprise aromatic and/or aliphatic double bonds,
Y is a di- to dodecavalent organic radical having 1 to 30 carbon atoms, which may comprise one or more oxygen atoms,
e is 0 or 1,
c is an integer from 1 to 11 and
g is 0 or 1,
with the proviso that the sum of e+g is ≤2,
and
basic catalysts (D), selected from the group of alkali metal hydroxides, alkali metal alkoxides and alkali metal siloxanolates,
are mixed with one another,
in a second step
the mixture obtained in the first step is allowed to react at temperatures of 80 to 170° C. and
in a third step
the reaction mixture obtained in the second step is neutralized with carboxylic acid derivatives having at least 4 carbon atoms (E).

In the context of the present invention, the term organopolysiloxanes is intended to encompass polymeric, oligomeric and also dimeric siloxanes.

Examples of hydrocarbon radicals R, R² and R³ are each independently alkyl radicals such as the methyl, ethyl, n-propyl, isopropyl, 1-n-butyl, 2-n-butyl, isobutyl, tert-butyl, n-pentyl, isopentyl, neopentyl, tert-pentyl radical, hexyl radicals such as the n-hexyl radical, heptyl radicals such as the n-heptyl radical, octyl radicals such as the n-octyl radical and isooctyl radicals such as the 2,2,4-trimethylpentyl radical, nonyl radicals such as the n-nonyl radical, decyl radicals such as the n-decyl radical, dodecyl radicals such as the n-dodecyl radical, and octadecyl radicals such as the n-octadecyl radical; and cycloalkyl radicals such as cyclopentyl, cyclohexyl, cycloheptyl and methylcyclohexyl radicals.

Examples of substituted radicals R, R² and R³ are each independently haloalkyl radicals such as the 2,2,2,2′,2′,2′-hexafluoroisopropyl radical, the 3,3,3-trifluoro-n-propyl radical, the heptafluoroisopropyl radical and haloaryl radicals such as the o-, m- and p-chlorophenyl radical.

Preferably, the radicals R, R² and R³ are each independently a monovalent hydrocarbon radical having 1 to 6 carbon atoms, particularly preferably the methyl radical.

Examples of unsaturated hydrocarbon radicals Q and Q¹ are each independently alkenyl radicals such as the vinyl, allyl, 5-hexen-1-yl, E-4-hexen-1-yl, Z-4-hexen-1-yl, 2-(3-cyclohexenyl)ethyl and cyclododeca-4,8-dienyl radical.

The radicals Q and Q¹ are each independently preferably radicals having an aliphatic double bond, particularly preferably the vinyl, allyl or 5-hexen-1-yl radical, especially the vinyl radical.

The siloxanes (A) used according to the invention are preferably substantially linear, branched or cyclic siloxanes, where the linear siloxanes may have terminal and/or pendant unsaturated groups.

The siloxanes (A) used according to the invention are particularly preferably those of the formula

QₕR₃₋ₕSiO(R₂SiO)ₓ(QRSIO)_{y}SiR₃₋ₕQₕ (IV),
where R and Q each have the definition stated above,
h is 0, 1, 2 or 3, preferably 1,
x is 0 or an integer from 1 to 500 and
y is 0 or an integer from 1 to 50, preferably 0, with the proviso that the compounds of the formula (IV) have at least one radical Q.

Although not shown in formula (IV), other siloxane units may be present in addition to the units shown in formula (IV), as a result of the preparation, such as siloxane units —SiO_{3/2}, which may be present as impurities, preferably up to a maximum of 10 mol %.

Examples of siloxanes (A) used according to the invention are
ViMe₂SiO(Me₂SiO)₁₀₋₂₀₀SiMe₂Vi,
allyl(Me₂)SiO(Me₂SiO)₁₀₋₂₀₀Si(Me₂)allyl,
ViEt₂SiO(Et₂SiO)₁₀₋₂₀₀SiEt₂Vi and
(5-hexen-1-yl)Me₂SiO(Me₂SiO)₁₀₋₂₀₀SiMe₂(5-hexen-1-yl), preferably
ViMe₂SiO(Me₂SiO)₁₀₋₁₀₀SiMe₂Vi,
allyl(Me₂)SiO(Me₂SiO)₁₀₋₁₀₀Si(Me₂)allyl,
ViEt₂SiO(Et₂SiO)₁₀₋₁₀₀SiEt₂Vi or
(5-hexen-1-yl)Me₂SiO(Me₂SiO)₁₀₋₁₀₀SiMe₂(5-hexen-1-yl), and particularly preferably
ViMe₂SiO(Me₂SiO)₁₀₋₂₀SiMe₂Vi,
allyl(Me₂)SiO(Me₂SiO)₁₀₋₂₀Si(Me₂)allyl,
ViEt₂SiO(Et₂SiO)₁₀₋₂₀SiEt₂Vi or
(5-hexen-1-yl)Me₂SiO(Me₂SiO)₁₀₋₂₀SiMe₂(5-hexen-1-yl), where Me is a methyl radical, Et is an ethyl radical, allyl is an allyl radical and Vi is a vinyl radical.

The organopolysiloxanes (A) used in accordance with the invention have a viscosity of preferably 5 to 100 000 mPa·s, preferably 10 to 100 mPa·s, in each case at 25° C.

The component (A) used in accordance with the invention is a commercially available product or can be produced by standard chemical processes.

In the method according to the invention, organopolysiloxanes (A) are preferably used in amounts of 1.0 to 40% by weight, preferably 10 to 30% by weight, based in each case on the total weight of the organosilicon compounds (A), (B) and optionally (C).

Examples of hydrocarbon radicals R¹ which may be interrupted by oxygen atoms are alkyl radicals such as the methyl, ethyl, n-propyl, isopropyl, 1-n-butyl, 2-n-butyl, isobutyl and tert-butyl radical and the methoxyethyl and the ethoxyethyl radical.

The radical R¹ is preferably a hydrogen atom or hydrocarbon radicals having 1 to 3 carbon atoms, particularly preferably a hydrogen atom or the methyl radical.

The organopolysiloxanes (B) used in the method according to the invention may be substantially linear, branched or cyclic, preferably substantially linear or cyclic.

A mixture of essentially linear siloxanes and cyclosiloxanes may also be used as component (B).

Preferably, the cyclic siloxanes (B) are those having preferably 3 to 20 silicon atoms, particularly preferably 3 to 8 silicon atoms, especially 4 to 6 silicon atoms.

If the organopolysiloxanes (B) used in the method according to the invention are cyclic siloxanes, they preferably do not have any groups (OR¹) where R¹ has the same definition stated above.

The essentially linear siloxanes (B) are preferably those of the general formula

(R¹O)R²₂SiO(R²₂SiO)_{z}SiR₂(OR¹) (V),
where
R² and R¹ each have the definition given for them above,
z is an integer from 20 to 100.

Although not shown in formula (V), other siloxane units may be present in addition to the units shown in formula (V), as a result of the preparation, such as siloxane units —SiO_{3/2}, which may be present as impurities, preferably up to a maximum of 10 mol %.

Examples of siloxanes (B) used according to the invention are
OHMe₂SiO(Me₂SiO)₁₀₋₅₀₀SiMe₂OH, OHEt₂SiO(Et₂Si)₁₀₋₅₀₀SiEt₂OH and [Si(Me₂)O]₃₋₂₀, preferably
OHMe₂SiO(Me₂SiO)₁₀₋₂₀₀SiMe₂OH, OHEt₂SiO(Et₂Si)₁₀₋₂₀₀SiEt₂OH or [Si(Me₂)O]₃₋₁₀ and
particularly preferably OHMe₂SiO(Me₂SiO)₁₀₋₁₀₀SiMe₂OH, OHEt₂SiO(Et₂Si)₁₀₋₁₀₀SiEt₂OH or [Si(Me₂)O]₃₋₈, where Me is a methyl radical and Et is an ethyl radical.

The organopolysiloxanes (B) used in accordance with the invention have a viscosity of preferably 1 to 100 000 mPa·s at 25° C., preferably 1 to 200 mPa·s at 25° C.

The component (B) used in accordance with the invention is a commercially available product or can be produced by standard chemical processes.

In the method according to the invention, organopolysiloxanes (B) are preferably used in amounts of 30 to 99% by weight, preferably 70 to 95% by weight, based in each case on the total weight of the organosilicon compounds (A), (B) and optionally (C).

The quotient of the number of carbon atoms in radical Y and the valence of Y is preferably at most 10, preferably at most 5 and particularly preferably at most 3.

Radical Y is preferably a linking organic unit having 1 to 24 carbon atoms between two to twelve siloxanyl units (Si atoms). Y is preferably divalent, trivalent or tetravalent, particularly preferably divalent.

Examples of Y are the methylene group, the methine group or tetravalent carbon, the 1,1-ethanediyl group and the 1,2-ethanediyl group, the 1,4-butanediyl group and the 1,3-butanediyl group.

If Y comprises at least 2 carbon atoms, this radical may also be unsaturated, for example the —CH═CH— group (cis or trans), the

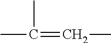

group and the —C═C— group.

Radical Y is particularly preferably an organic unit having a maximum of 12 carbon atoms, especially preferably having 2 carbon atoms. Examples of particularly preferred radicals Y are —CH₂CH₂—, —CH(CH₃)—, —CH═CH—, —C(═CH₂)— or —C≡C—.

Examples of organosilicon compounds (C) optionally used are substantially linear, branched, crosslinked or cyclic siloxanes.

The organosilicon compounds (C) optionally used are preferably those of the formula

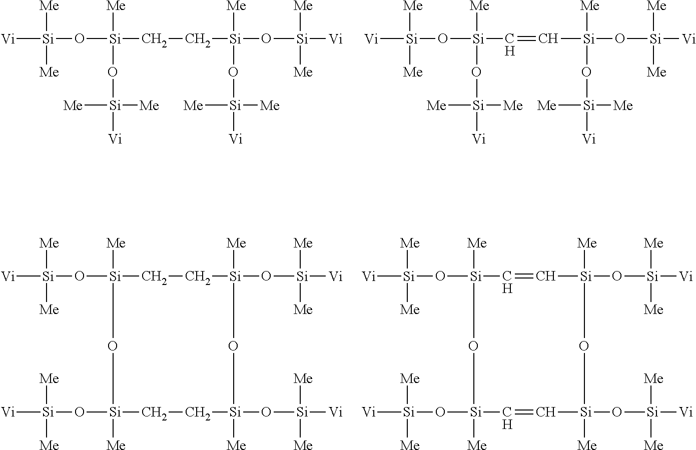

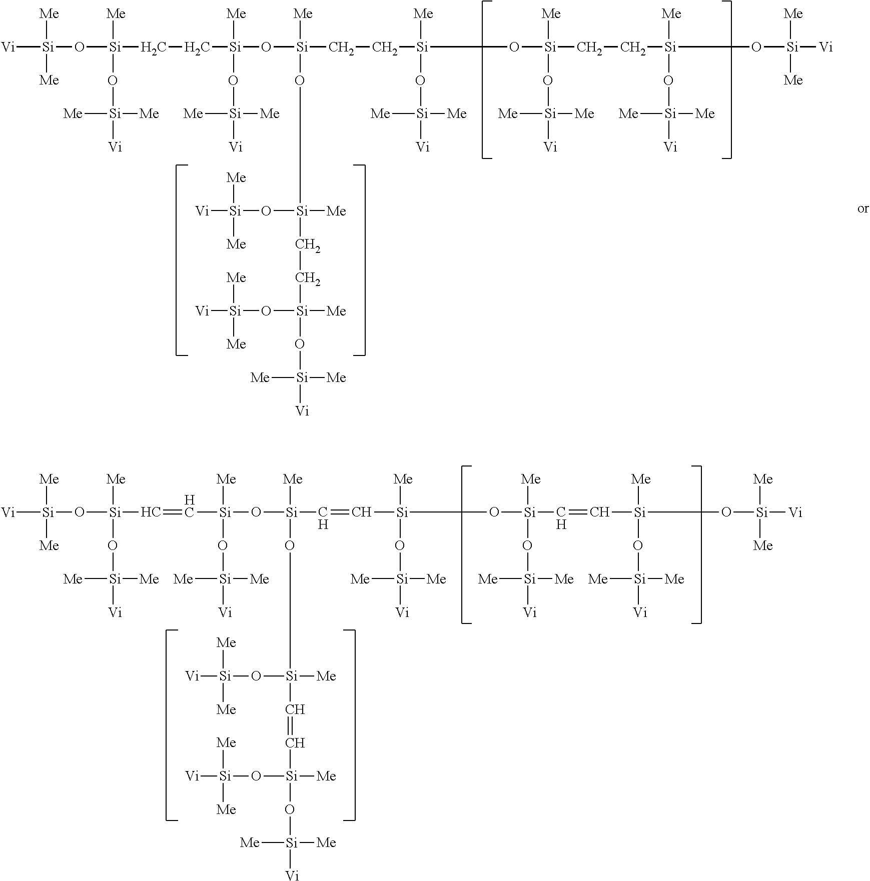

The organopolysiloxanes (C) optionally used in accordance with the invention have a viscosity of preferably 1 to 1000 mPa·s at 25° C., preferably 1 to 200 mPa·s at 25° C.

The organopolysiloxanes (C) optionally used according to the invention have an iodine number of preferably 20 to 200, preferably 50 to 150 mPa·s at 25° C.

The iodine number is the number which indicates the amount of iodine consumed in the addition to the aliphatic multiple bond in grams per 100 grams of material used for analysis.

If organosilicon compounds (C) are used in the method according to the invention, the amounts involved are preferably 1 to 20% by weight, preferably 2 to 10% by weight, based in each case on the total weight of the organosilicon compounds (A), (B) and (C). Component (C) is preferably used in the method according to the invention.

The component (C) optionally used according to the invention is a compound which can be prepared by standard chemical processes. For example, EP-A 1917292 describes organopolysiloxane compounds which comprise at least one structural unit per molecule of the general formula O_{3-a/2}RₐSi—Y(SiRₐO_{3-a/2})_{b}, where R may be the same or different and is a monovalent SiC-bonded organic radical having 1 to 30 carbon atoms, which may comprise one or more N and/or O atoms, Y is a divalent to dodecavalent organic radical having 1 to 30 carbon atoms, which may comprise one or more O atoms, a is 0 or 1 and b is an integer from 1 to 11.

Preferred examples of the alkali metal hydroxides (D) used according to the invention are potassium hydroxide or sodium hydroxide, preferably potassium hydroxide.

Preferred examples of the alkali metal alkoxides (D) used in the method according to the invention are sodium methoxide, sodium ethoxide, potassium methoxide or potassium ethoxide, particularly preferably sodium methoxide or potassium methoxide.

Preferred examples of the alkali metal siloxanates (D) used in the method according to the invention are sodium siloxanolates, potassium siloxanolates or lithium siloxanolates, particularly preferably sodium siloxanolates or potassium siloxanolates, especially Na—O—[Si(Me)₂-O]ₙ—Si(Me)₂-O—Na, Na—O—[Si(Me)₂-O]ₙ—Si(Me)₃, K—O—[Si(Me)₂-O]ₙ—Si(Me)₂-O—K and K—O—[Si(Me)₂-O]ₙ—Si(Me)₃, where Me is a methyl radical and n is a number from 10 to 500.

In the method according to the invention, alkali metal hydroxides are preferably used as catalysts (D), especially potassium hydroxide.

In the method according to the invention catalysts (D) can be used in pure form or as a mixture with organic solvent, the latter being preferred.

Particularly preferably, in the method according to the invention, catalysts (D) are used in a mixture with alcohol, preferably methanol, preferably a 20% by weight mixture in methanol in the case of KOH and preferably a 30% by weight mixture in methanol in the case of sodium methoxide.

In the method according to the invention, catalysts (D) are preferably used in amounts of 1 to 1000 ppm by weight, preferably 10 to 400 ppm by weight, particularly preferably 30 to 200 ppm by weight, in each case calculated as pure substance and based on the total weight of the organosilicon compounds (A) and (B) and optionally (C).

The basic catalyst (D) is deactivated by using, at the end of the reaction according to the invention, neutralizing agents (E) which form, with the basic catalysts (D), neutralization products which are preferably largely soluble in the siloxane produced at 25° C. and 1013 hPa. In the context of the invention, largely soluble means that the neutralization product formed is preferably dissolved to an extent of at least 60% by weight, particularly preferably at least 80% by weight, in particular completely, in the organopolysiloxane produced.

The carboxylic acid derivatives (E) used according to the invention preferably have at least 8 carbon atoms.

Examples of such neutralizing agents (E) are long-chain carboxylic acids that are liquid at room temperature and ambient pressure, such as n-octanoic acid, 2-ethylhexanoic acid, n-nonanoic acid, 2-butyloctanoic acid, 2-butyldecanoic acid, 2-butyldodecanoic acid, 2-hexyldecanoic acid, 2-heptylundecanoic acid, 2-octyldodecanoic acid, 2-decyltetradecenoic acid, undecenoic acid, oleic acid, carbonic esters such as propylene carbonate, or carboxylic anhydrides such as octenylsuccinic anhydride.

The neutralizing agents (E) used according to the invention are preferably 2-ethylhexanoic acid, 2-butyloctanoic acid, 2-hexyldecanoic acid or 2-octyldodecanoic acid, particularly preferably 2-butyloctanoic acid.

The amount of neutralizing agents (E) required depends on the amount of basic catalysts (D) used and is preferably 1 to 10 equivalents, preferably 1.2 to 5 equivalents, particularly preferably 1.5 to 2.5 equivalents, based in each case on catalyst (D) in the pure state.

The method according to the invention can be carried out in the presence or absence of organic solvents (L), although the use of solvents (L) is not preferred. Examples of suitable solvents (L) are alcohols, such as methanol, ethanol, n-propanol, isopropanol; ethers such as dioxane, tetrahydrofuran, diethyl ether, diethylene glycol dimethyl ether; chlorinated hydrocarbons such as dichloromethane, trichloromethane, tetrachloromethane, 1,2-dichloroethane, trichlorethylene; hydrocarbons such as pentane, n-hexane, hexane isomer mixtures, heptane, octane, petroleum benzine, petroleum ether, benzene, toluene, xylenes; ketones such as acetone, methyl ethyl ketone, methyl isobutyl ketone; carbon disulfide and nitrobenzene, or mixtures of these solvents.

The term “solvent” does not mean that all reaction components must dissolve therein. The reaction according to the invention may also be carried out in a suspension or emulsion of one or more reactants.

The components used in the method according to the invention may each be one type of such a component or else a mixture of at least two types of a respective component.

In the first step of the method according to the invention, components (A), (B), optionally (C) and basic catalyst (D) are mixed in any manner, such as by a propeller stirrer. The sequence in which the different constituents are mixed together may be varied as desired, with preference being given to adding catalyst (D) to a mixture of components (A), (B), optionally (C).

The first step of the method according to the invention is preferably carried out at the pressure of the surrounding atmosphere, that is to say about 900 to 1100 hPa.

The first step of the method according to the invention is preferably carried out at a temperature of 20° C. to 90° C., particularly preferably 20° C. to 85° C.

The first step of the method according to the invention is preferably carried out under a protective gas such as nitrogen or argon.

In the second step of the method according to the invention, the temperature is preferably 90° C. to 150° C., particularly preferably 110° C. to 140° C.

The second step of the method according to the invention is carried out at a pressure of preferably 20 to 1100 hPa, preferably 100 to 1013 hPa, particular preference being given to reducing the pressure intermittently or continuously in order to remove volatile compounds and/or air. In a preferred procedure of the second step according to the invention, the pressure is intermittently or continuously reduced to 30 to 500 hPa, followed by admission of protective gas. In a further preferred method variant, if cyclosiloxanes are used as component (B), the second step is carried out at the pressure of the surrounding atmosphere, i.e. at 900 to 1100 hPa.

If in the second step volatile compounds are removed, they are preferably water and/or alcohol.

The second step of the method according to the invention is preferably carried out for a period of 10 to 240 minutes, particularly preferably 30 to 180 minutes. The duration depends on the catalyst used, the amount of catalyst, the reaction temperature and the desired degree of equilibration or degree of condensation and can be adjusted depending on the procedure.

After the reaction has taken place, the reaction mixture is further processed in a third step according to the invention by adding neutralizing agent (E).

The third step of the method according to the invention is preferably carried out at a temperature of 100° C. to 160° C., particularly preferably 120° C. to 150° C.

The third step of the method according to the invention is preferably carried out at the pressure of the surrounding atmosphere, i.e. about 1013 hPa.

The third step of the method according to the invention is preferably carried out under a protective gas such as nitrogen or argon.

One preferred variant of the method is characterized in that
in a first step
organopolysiloxanes (A), organopolysiloxanes (B) and optionally organopolysiloxane compounds (C) are initially charged at room temperature and catalyst (D) is metered in at a temperature of 20 to 90° C. and they are mixed with one another,
in a second step
the mixture obtained in the first step is allowed to react at temperatures of 90 to 150° C. and a pressure of 20 to 1100 hPa and
in a third step
the reaction mixture obtained in the second step is neutralized with component (E) at a temperature of 100 to 160° C.

One particularly preferred variant of the method is characterized in that
in a first step
organopolysiloxanes (A), cyclosiloxanes (B) and optionally organopolysiloxane compounds (C) are initially charged at room temperature and catalyst (D) is metered in at a temperature of 20 to 90° C. and they are mixed with one another,
in a second step
the mixture obtained in the first step is allowed to react at temperatures of 90 to 150° C. and a pressure of 20 to 1100 hPa and
in a third step
the reaction mixture obtained in the second step is neutralized with component (E) at a temperature of 100 to 160° C.

A further preferred variant of the method is characterized in that
in a first step
organopolysiloxanes (A), organopolysiloxanes (B) and organopolysiloxane compounds (C) are initially charged at room temperature and catalyst (D) is metered in at a temperature of 20 to 90° C. and they are mixed with one another,
in a second step
the mixture obtained in the first step is allowed to react at temperatures of 90 to 150° C. and a pressure of 20 to 1100 hPa and
in a third step
the reaction mixture obtained in the second step is neutralized with component (E) at a temperature of 100 to 160° C.

The reaction mixture obtained in the third step can now—if desired—be worked up by any methods known to date. For example, it can be freed from volatile constituents, especially cycles, by distillation. If the reaction mixture is to be worked up by distillation after completion of the third step, the distillation is preferably carried out at temperatures of 140 to 170° C. and a pressure of 1 to 50 hPa.

The method according to the invention can be carried out in a batchwise, semi-continuous or fully continuous manner.

The method according to the invention gives a liquid which is clear at room temperature and ambient pressure, which advantageously does not have to be filtered, since the neutralization product of catalyst (D) and component (E) is largely dissolved in the siloxane matrix. The liquid produced according to the invention preferably does not comprise component (D).

According to the method of the invention, unsaturated organopolysiloxanes are obtained, which may be substantially linear or branched, where the unsaturated radicals may be terminal and/or pendant. The siloxanes produced by the method according to the invention are preferably present as a mixture with the neutralization product of the components (D) and (E) and optionally excess component (E).

The viscosity of the organopolysiloxanes produced by the method according to the invention can vary over a wide range, the viscosity preferably being in the range from 10 to 100 000 mPa·s, particularly preferably 50 to 1000 mPa·s.

The iodine number of the organopolysiloxanes produced by the method according to the invention can vary over a wide range, the iodine number preferably being in the range from 1 to 100, particularly preferably 2 to 20.

The organopolysiloxanes produced according to the invention exhibit a turbidity of preferably 0 to 65 FTU, particularly preferably 0 to 35 FTU.

The turbidity measurement in the context of the invention is based on the DIN EN 27027 standard. The turbidity values stated are based on the scattered light measured at an angle of 25°. For the measurement, the samples are filled preferably in a bubble-free manner into a 250 ml glass flask (diameter: 68 mm, height: 115 mm) and measured with the LabScat instrument from Sigrist at a wavelength of 650 nm. The results are given in the unit FTU (Formazine Turbidity Unit).

The organopolysiloxanes produced according to the invention may now be used for any purpose known to date. If desired, they can be mixed with inhibitors such as ethynylcyclohexanol or diallyl maleate, or anti-misting additives and put to further use.

The method according to the invention has the advantage that it is very easy to carry out.

The method according to the invention has the advantage that polyorganosiloxanes having unsaturated radicals can be prepared reproducibly—regardless of the silanol value of the reactants.

Furthermore, the method according to the invention has the advantage that clear products are obtained which are stable over a long period of time.

The method according to the invention has the advantage that the viscosity and the content of unsaturated groups in the product can be adjusted flexibly in a simple manner by changing the stoichiometry.

The method according to the invention has the advantage of being economical, since the compounds separated off by distillation, such as cyclosiloxanes, can be reused.

In the examples below all reported quantities in parts and percentages are based on weight unless otherwise stated. Unless otherwise stated, the following examples are carried out at a pressure of the ambient atmosphere, i.e. at about 1013 hPa, and at room temperature, i.e. about 23° C., or a temperature that arises when the reactants are combined at room temperature without additional heating or cooling. All viscosity data given in the examples are intended to refer to a temperature of 25° C.

The viscosity measurements in the context of the invention are carried out in accordance with the standards DIN 51562 (Ubbelohde) and DIN EN ISO 2555 (Brookfield). The measurements analogous to DIN 51562 are carried out at 25° C. and are specified in the unit mm²/s. The measurements analogous to DIN EN ISO 2555 are carried out at 25° C. with the DV2T Extra viscometer from Brookfield and are stated in the unit mPa·s.

### Method for Producing the Star Polymer (C1)

A mixture of 109 g of redistilled 1,2-bis(methyldichlorosilyl)ethane (1.7 eq. Cl) and 820 g of vinyldimethylchlorosilane (6.8 eq. Cl) is cooled to 10° C. With stirring and simultaneous cooling, within about 80 minutes, a total of 1.7 l of 5% HCl solution are metered in so that the temperature of the reaction mixture can be maintained at 10-20° C. The mixture is then stirred vigorously for 30 minutes and then the phases are separated. The siloxane phase is washed 4 times with 1 l of water each time, neutralized with 0.5 l of 5% NaHCO₃ solution and washed again with 1 l of water. Volatile hydrolysis products are removed in vacuo at up to 80° C. (mainly divinyltetramethyldisiloxane). 149.8 g of a clear liquid are obtained as residue having a viscosity of 7.2 mm²/s (25° C.) and, with an iodine number of 169.6, exactly one C═C double bond per 149.8 g. The end groups/branching unit ratio is 2.57. The product comprises ca. 90% of the 1,2-bis(methyldichlorosilyl)ethane used in hydrolyzed form.

### EXAMPLE 1

A branched vinyl polymer is produced from the star polymer (C1) prepared above having an iodine number of 169.6 by equilibration with two linear siloxanes. For this purpose, 32.5 g of the star polymer (C1) are mixed with 177.7 g of an α,ω-divinyl-terminated dimethylpolysiloxane having a viscosity of 25 mm²/s and an iodine number of 25.0, 596.9 g of an α,ω-dihydroxy-terminated dimethylpolysiloxane having a viscosity of 70 mm²/s and 0.04 g of KOH, and condensed and equilibrated at 140° C. and a pressure of 200 hPa. After 2 hours, the catalyst is deactivated with 0.3 g of 2-butyloctanoic acid at a temperature of 140° C. and at a pressure of 1013 hPa. The crude product is freed from the volatile constituents octamethylcyclotetrasiloxane, decamethylcyclopentasiloxane and dodecamethylcyclohexasiloxane at 140° C. and a pressure of 10 hPa. This gives a colorless, clear silicone oil having a viscosity of 210 mm²/s, an iodine number of 10.3 and a turbidity of 0.72 FTU.

### EXAMPLE 2

A branched vinyl polymer is produced from the star polymer (C1) prepared above having an iodine number of 169.6 by equilibration with one linear and one cyclic siloxane. For this purpose, 32.5 g of the star polymer (C1) are mixed with 177.7 g of an α,ω-divinyl-terminated dimethylpolysiloxane having a viscosity of 25 mm²/s and an iodine number of 25.0 and with 596.9 g of a mixture of octamethylcyclotetrasiloxane and decamethylcyclopentasiloxane in a ratio by weight of D4 to D5 of 25 to 75 and 0.04 g of KOH, and equilibrated at 140° C. and a pressure of 1013 hPa. After 2 hours, the catalyst is deactivated with 0.3 g of 2-butyloctanoic acid at a temperature of 140° C. and at a pressure of 1013 hPa. The crude product is freed from volatile constituents octamethylcyclotetrasiloxane, decamethylcyclopentasiloxane and dodecamethylcyclohexasiloxane at 140° C. and a pressure of 10 hPa. This gives a colorless, clear silicone oil having a viscosity of 215 mm²/s, an iodine number of 10.2 and a turbidity of 1.08 FTU.

### EXAMPLE 3

An α,ω-divinyl-terminated dimethylpolysiloxane is produced from an α,ω-divinyl-terminated dimethylpolysiloxane by equilibration with an α,ω-dihydroxy-terminated dimethylpolysiloxane. For this purpose, 56.1 g of an α,ω-divinyl-terminated dimethylpolysiloxane having a viscosity of 25 mm²/s and an iodine number of 25.0 are mixed with 165.8 g of an α,ω-dihydroxy-terminated dimethylpolysiloxane having a viscosity of 70 mm²/s, and condensed and equilibrated at 140° C. and a pressure of 200 hPa with catalysis by 0.010 g of KOH. After 2 hours, the catalyst is deactivated with 0.088 g of 2-butyloctanoic acid at a temperature of 140° C. and at a pressure of 1013 hPa. The crude product is freed from volatile components at 140° C. at 10 hPa. This gives a colorless, clear silicone oil having a viscosity of 190 mm²/s, an iodine number of 6.9 and a turbidity of 0.98 FTU.

1-10. (canceled)

11. A method for producing organopolysiloxanes having unsaturated groups, comprising:
wherein in a first step organopolysiloxanes (A), organopolysiloxanes (B), catalysts (D) and optionally organopolysiloxane compounds (C) are provided and mixed together,
wherein the organopolysiloxanes (A) comprise units of the formula (I)
RₐQ_{b}SiO_{(4-a-b)/2} (I),
wherein R may be the same or different and is a monovalent, saturated hydrocarbon radical having 1 to 18 carbon atoms and optionally substituted by fluorine, chlorine or bromine atoms,
wherein Q may be the same or different and is unsaturated hydrocarbon radicals which may comprise aromatic and/or aliphatic double bonds,
wherein a is 0, 1, 2 or 3,
wherein b is 0, 1, 2 or 3, and
wherein the sum of a+b is ≤3 and the organopolysiloxanes (A) have at least one radical Q,
wherein the organopolysiloxanes (B) comprise units of the formula (II)
R²_{d}(OR¹)_{f}SiO_{(4-d-f)/2} (II),
wherein R² may be the same or different and is a monovalent, saturated hydrocarbon radical having 1 to 18 carbon atoms and optionally substituted by fluorine, chlorine or bromine atoms,
wherein R¹ may be the same or different and is a hydrogen atom or alkyl radicals having 1 to 4 carbon atoms which may be substituted by oxygen atoms,
wherein d is 0, 1, 2 or 3,
wherein f is 0, 1, 2 or 3, and
wherein the sum of d+f is ≤3,
wherein the optional organopolysiloxane compounds (C) comprise at least one structural unit per molecule of the general formula (III)
O_{3-(e+g)/2}R³ₑQ¹_{g}Si—Y(SiR³ₑQ¹_{g}O_{3-(e+g)/2})_{c} (III)
wherein R³ may be the same or different and is a monovalent, saturated hydrocarbon radical having 1 to 18 carbon atoms and optionally substituted by fluorine, chlorine or bromine atoms,
wherein Q¹ may be the same or different and is unsaturated hydrocarbon radicals which may comprise aromatic and/or aliphatic double bonds,
wherein Y is a di- to dodecavalent organic radical having 1 to 30 carbon atoms, which may comprise one or more oxygen atoms,
wherein e is 0 or 1,
wherein c is an integer from 1 to 11,
wherein g is 0 or 1, and
wherein the sum of e+g is ≤2,
wherein the basic catalysts (D), are selected from the group of alkali metal hydroxides, alkali metal alkoxides and alkali metal siloxanolates;
wherein in a second step the mixture obtained in the first step is allowed to react at temperatures of 80 to 170° C.; and
wherein in a third step the reaction mixture obtained in the second step is neutralized with carboxylic acid derivatives having at least 4 carbon atoms (E).

12. The method of claim 11, wherein the organopolysiloxanes (A) are used in amounts of 1.0 to 40% by weight, based on the total weight of the organosilicon compounds (A), (B) and optionally (C).

13. The method of claim 11, wherein the organopolysiloxanes (B) are used in amounts of 30 to 99% by weight, based on the total weight of the organosilicon compounds (A), (B) and optionally (C).

14. The method of claim 11, wherein the optional organopolysiloxane compounds (C) are used.

15. The method of claim 11, wherein the alkali metal hydroxides are used as the catalysts (D).

16. The method of claim 11, wherein the carboxylic acid derivatives (E) used have at least 8 carbon atoms.

17. The method of claim 11, wherein the second step is carried out at a pressure of 20 to 1100 hPa.

18. The method of claim 11, wherein in the first step the organopolysiloxanes (A), the organopolysiloxanes (B) and the optional organopolysiloxane compounds (C) are initially charged at room temperature and the catalyst (D) is metered in at a temperature of 20 to 90° C. and are mixed with one another;
wherein in the second step the mixture obtained in the first step is allowed to react at temperatures of 90 to 150° C. and a pressure of 20 to 1100 hPa; and
wherein in the third step the reaction mixture obtained in the second step is neutralized with carboxylic acid derivatives (E) at a temperature of 100 to 160° C.

19. The method of claim 11, wherein the reaction mixture after completion of the third step is worked up by distillation, the distillation being carried out at temperatures of 140 to 170° C. and a pressure of 1 to 50 hPa.

20. The method of claim 11, wherein the product obtained has a turbidity of 0 to 65 FTU.
